(19) United States
(12) Patent Application Publication
(10) Pub. No.: US 2008/0022599 A1
(43) Pub. Date: Jan. 31, 2008

(54) Door sill

(76) Inventors: Christian Fischer, Hunderdorf (DE); Marc Freis, Bogen (DE); Elmar Knepper, Bogen (DE); Markus Fraundorfer, Eichendorf (DE)

Correspondence Address: DAY PITNEY LLP, 7 TIMES SQUARE, NEW YORK, NY, 10036-7311, US

(21) Appl. No.: 11/821,884

(22) Filed: Jun. 26, 2007

(30) Foreign Application Priority Data
Jun. 27, 2006 (DE) 10 2006 029 353.3

(51) Int. Cl. E06B 1/70

(52) U.S. Cl. 49/468

(57) ABSTRACT

This invention relates to a door such as a balcony or patio door, featuring a threshold which, to accommodate handicapped traffic, is partly retractable, automatically dropping from its normal base position into its transit position, while by the actuation of a control mechanism it is restorable from the transit position to its normal base position, in a manner whereby in its transit position it permits unimpeded passage for handicapped persons from the inside to the outside and vice versa.

This invention relates to a door, such as a balcony or patio door, encompassing an integrated preformed threshold module with door-wing weather stripping.

Doors, in particular house doors, have been a fairly notorious problem area. DE 101 07 170 A1, for example, describes a threshold assembly which, consisting of a preformed threshold sill with weather stripping for instance of the sealing-lip type, is mounted on the door wing or door frame. Another threshold, likewise provided with weather stripping, is described in DE 198 43 736. DE 198 43 736 also describes a threshold for the handicapped, specifically featuring water-repellent profiles that can be matched with door-step profiles and, contoured in a particular shape, can be traversed by a wheel chair.

However, these doors, i.e. their thresholds, fall short of handicapped requirements. They also exceed considerably the prescribed threshold height limit of 20 mm.

It is therefore the objective of this invention to introduce a door as specified in the claims, with a threshold that is handicapped-friendly, thermally insulating and impact sound absorbing.

The particular benefit derived from the configuration according to the invention, especially that of the threshold, lies in the fact that, apart from being handicapped-friendly by not exceeding the Hₘₐₓ of 20 mm specified by DIN 18025, it also offers the advantages of a stop rail with corresponding sealing and thermal insulation characteristics. Moreover, the threshold is easy to clean and for the contractor easy to install.

The following will explain the invention in more detail with the aid of an exemplified embodiment illustrated in the attached drawings in which:

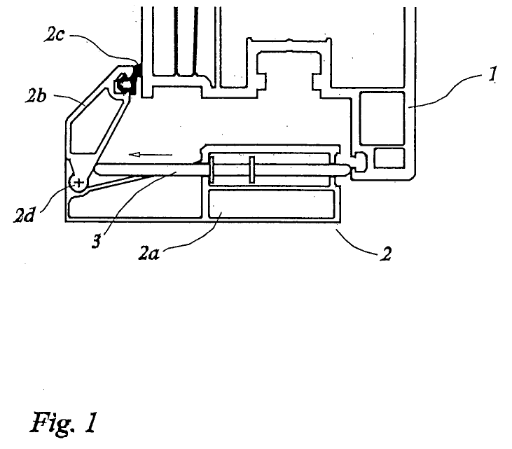

FIG. 1 is a cross-sectional view of the threshold in its normal base position;

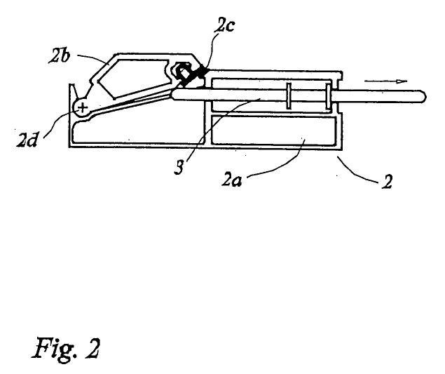

FIG. 2 same as in FIG. 1 except in its retracted transit position;

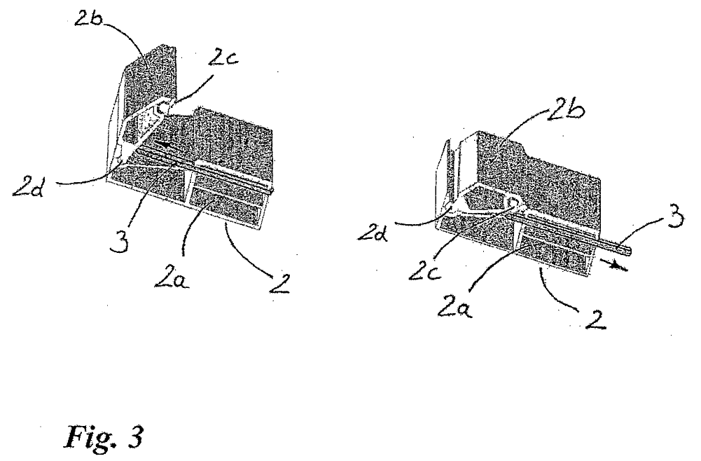

FIG. 3 shows two perspective aspects of the threshold.

As will be evident from the cross-sectional illustration of a door-wing 1 and its associated threshold 2, the threshold is of a movable design, i.e. it is partly retractable. This concept is particularly useful for balcony and patio doors.

FIG. 1 shows the system in its normal base position with the door-wing 1 closed while FIG. 2 shows it in its transit position.

In the normal base position the outer sill 2b of the threshold 2 is tilted up, its sealing strip 2c making tight contact with the door-wing 1, while the control element 3 of the actuating mechanism is moved to the left where, in this normal base position, it is held in place by the door-wing 1. The moment the door is opened, the weight of the sill 2b causes the control element to rotate around its pivot 2d into the transit position, which pivot 2 is situated on the outside within the opening clearance of the body 2a of the threshold 2. In this transit position the sill 2b does not exceed the permissible height, specified per DIN 18025, of 20 mm above the floor level, thus enabling handicapped persons to traverse the threshold without difficulty.

As the door-wing 1 is closed, the control element 3 moves the threshold 2 from its transit position back into its normal base position where it is held in place by the closed door-wing 1.

If dirt were to accumulate in the opening space of the threshold 2, it can be removed by simply lifting the latter off its pivot 2d.

Of course, actuating the sill 2b can also be accomplished by means other than the door-wing 1 or through gravity, i.e. the weight of the sill 2a [sic] moving the control element 3. For example, the control element may be moved by means of a magnetic, electromagnetic or similar drive.

### LIST OF REFERENCE NUMBERS

1. Door
2. Threshold, 2a body, 2b sill, 2c seal, 2d pivot
3. Control element

1. Door, such as a balcony or patio door, encompassing an integrated preformed threshold module with door-wing weather stripping, characterized in that the threshold (2) is designed as a movable, handicapped-friendly component.

2. Door as in claim 1, characterized in that its threshold (2) is at least partly retractable, automatically dropping under its own weight from its normal base position into a passable transit position when the door is opened and permitting restoration to its normal base position by means of a control element (3) actuated by the door-wing (1).

3. Door as in claim 1, characterized in that said control element (3) is slide-mounted in the threshold.

4. Door as in claims 1 and 2, characterized in that said control element (3) is forcibly guided in the threshold (2).

5. Door as in claims 1 to 3, characterized in that the control element (3) is equipped with a magnetic or electromagnetic drive.

6. Door as in claims 1 to 4, characterized in that in its transit position, the maximum height Hₘₐₓ of the threshold (2) will not exceed 20 mm.
